(19) United States
(12) Patent Application Publication
(10) Pub. No.: US 2010/0291934 A1
(43) Pub. Date: Nov. 18, 2010

(54) PHYSICAL-LAYER CELL IDENTITY ASSIGNMENT IN A COMMUNICATION SYSTEM

(75) Inventor: Luis Lopes, Swindon (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/466,005

(22) Filed: May 14, 2009

(51) Int. Cl. H04W 84/00

(52) U.S. Cl. 455/446

(57) ABSTRACT

A system and method for physical cell identity assignment in a wireless communication system includes a first step 500 of starting up a new cell in the communication system. A next step 502 includes allocating a temporary operating frequency for the new cell. A next step 506 includes building a list of physical cell identity assignments being used by neighbouring cells. A next step 508 includes configuring the new cell with a permanent physical cell identity assignment that is not being used in the list.

### FIELD OF THE INVENTION

The invention relates to wireless communication systems, and in particular to physical-layer cell identity assignment in a communication system.

### BACKGROUND OF THE INVENTION

Currently 3^{rd} generation (3G) cellular communication systems based on Code Division Multiple Access (CDMA) technology, such as the Universal Mobile Telecommunication System (UMTS), are being deployed, and 4^{th} generation (4G) communication systems such as Worldwide Interoperability for Microwave Access (WiMAX) and Long Term Evolution (LTE) are being planned. In the 4G LTE system, cells are identified both by a global cell identification similar to the Global System for Mobile (GSM) Cell ID as is presently used, and also a short form called the Physical Cell ID (PCID). User equipment (UE) in idle mode only sees the PCID. UEs in active mode only report the PCI of neighbours unless specifically asked by the serving cell to get the global cell identification. The problem with the PCID is that it has a cardinality of 504, and therefore careful planning is required to ensure that there is no identity confusion with neighbouring cells. Therefore, the problem with cell PCID is very similar to that faced in GSM frequency and macro base station identity code (BSIC) planning, except that there are more PCIDs to choose from, and adjacent PCIDs do not pose a problem. In currently deployed 3G communication systems, each cell has a relatively low number of neighbours, and therefore UEs receive a neighbour list identifying a relatively small number of PCIDs of neighbour cells as potential handover targets. Extending the current approach to 4G scenarios where a UE may need to consider large numbers of neighbouring cells is not practical. Furthermore, there is a requirement in 4G to reduce the planning effort involved in providing both the cells' and neighbours' PCIDs from a central operations centre.

The problem of extending current approach to scenarios where there are many cells is how to efficiently assign a PCID in a way that uniquely and efficiently identifies a cell in its large neighbourhood. Specifically, it is not practically feasible to assign individual pilot signal scrambling codes or frequency/base station identity combinations to each cell and to identify all potential handover cells, including femto-cells, as neighbours of the cell as this would require very large neighbour lists and considerable planning effort to avoid instances of multiple cells with the same PCID. It would furthermore require significant operations and management resource in order to configure each cell with the large number of neighbours and would complicate network management, planning and optimisation. It would also increase the size of the configuration database and significantly increase the number of configuration change notifications sent around the network. In addition, the sharing of PCIDs of the cells results in a target ambiguity and prevents the mobile station from uniquely identifying a potential handover target. For example, if a group of base stations supporting different cells is using an identical PCID, a mobile station detecting the presence of this shared PCID will be aware that a potential handover target has been detected but will not be able to uniquely identify and report which of the underlay cells has been detected. Although the UE can be asked to resolve a PCI uncertainty by fetching the eCGI of the Cell with that PCID, the use of this procedure should be minimised as it places additional load on the UE, and delays a time critical handover.

One solution to this problem is to utilize centralised radio frequency planning tools for frequency planning and managing cell identities. However, this is difficult to implement due to the nature of 4G cells that can appear and disappear from the network quite rapidly and in large numbers. This solution is also expensive in that it requires substantial interaction by planners and operators, as the plan is initially created in an external model of the network, and this model needs to be kept up to date with the real sites on the ground.

Another solution would have a new cell first scan the radio environment so that it detects PCIDs already being used. However, this would require an additional downlink scanning receiver, and would still not guarantee a unique PCID for the cell. Also, the scanning receiver may not always provide good data (depending on antenna mounting, it may give a much smaller or much bigger coverage area than the actual cell).

Another solution would have unique temporary PCIDs allocated on a queue basis by an operations and maintenance centre (OMC). The temporary PCIDs are reserved and unused so the cell can safely come up and measure the neighbour cells. Although an improvement in the art, the lease of temporary PCIDs means that some PCIDs must be reserved. The more PCIDs that are reserved, the faster the introduction of new eNBs may be done (noting that the lease must last for as long as it takes for an eNB to reach high confidence in a permanent PCID, which could take a long time). However, the use of reserved PCIDs leaves fewer PCIDs available for permanent allocations.

Therefore, what is needed is a PCID planning process that is removed from a centralized function that requires extensive planner/operator interaction. It would be of further benefit if cells could have the ability to choose a PCID autonomously, while minimizing potential conflicts with neighbouring cells.

### BRIEF DESCRIPTION OF THE DRAWINGS

The invention is pointed out with particularity in the appended claims. However, other features of the invention will become more apparent and the invention will be best understood by referring to the following detailed description in conjunction with the accompanying drawings in which:

FIG. 1 illustrates an example of a communication system in accordance with the present invention;

FIG. 2 illustrates an example of a call flow for a first embodiment of the present invention;

FIG. 3 illustrates an example of a call flow for a second embodiment of the present invention;

FIG. 4 illustrates an example of a call flow for a third embodiment of the present invention; and

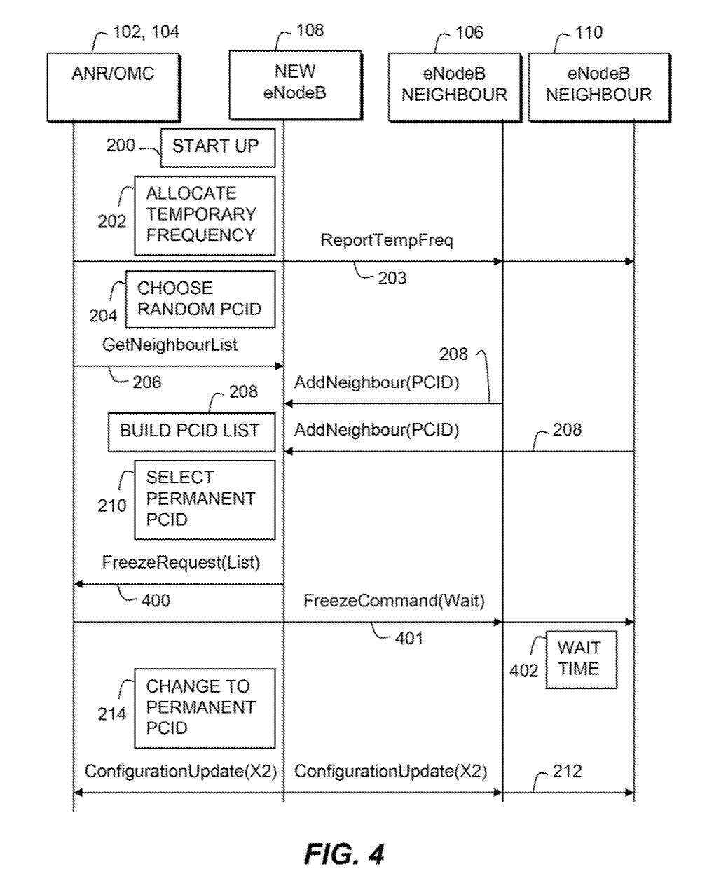

FIG. 5 illustrates an example of a method, in accordance with some embodiments of the invention.

Skilled artisans will appreciate that common but well-understood elements that are useful or necessary in a commercially feasible embodiment are typically not depicted or described in order to facilitate a less obstructed view of these various embodiments of the present invention.

### DETAILED DESCRIPTION OF EMBODIMENTS OF THE INVENTION

The present invention enables a distributed PCID planning process that removes a purely centralized control function that requires extensive planner/operator interaction. In particular, the present invention enables a distributed self organizing network (SON) that allows a new cell to choose a PCID autonomously, while minimizing potential conflicts with neighbouring cells.

The following description focuses on embodiments of the invention applicable to 4G communication systems such as LTE and WiMAX. For example, the present invention can be implemented for LTE enhanced NodeBs (eNB) and LTE centralised-SON where the functionality is lightweight enough so that it could be hosted in an element management system (EMS) for small networks, or an OMC for large networks. Alternatively, each eNB could host the functionality of the present invention. The present invention could also be applied to the WiMAX base stations. However, it will be appreciated that the invention is not limited to these applications but may be applied to many other cellular communication systems such as a 3GPP (Third Generation Partnership Project) E-UTRA (Evolutionary UMTS Terrestrial Radio Access) standard, a 3GPP2 (Third Generation Partnership Project 2) Evolution communication system, a CDMA (Code Division Multiple Access) 2000 1XEV-DV communication system, a Wireless Local Area Network (WLAN) communication system as described by the IEEE (Institute of Electrical and Electronics Engineers) 802.xx standards, for example, the 802.11a/HiperLAN2, 802.11g, 802.16, or 802.21 standards, or any of multiple other proposed ultrawideband (UWB) communication systems.

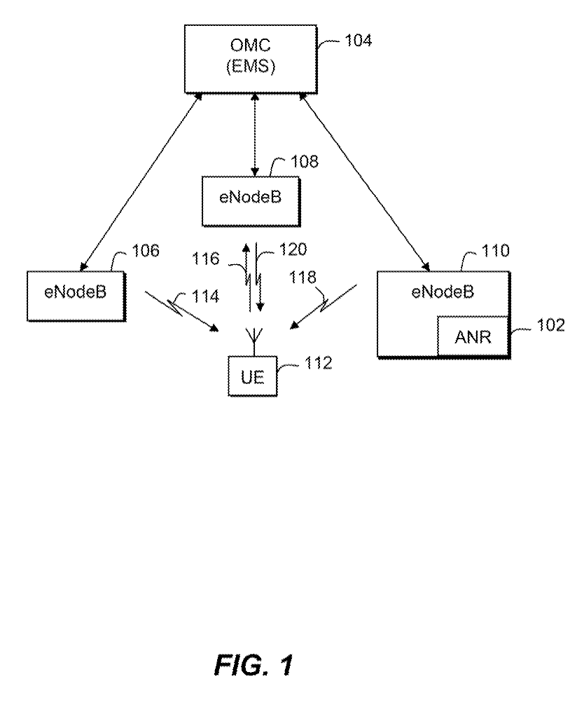

FIG. 1 illustrates an example of a cellular communication system which in the specific example is a 4G LTE communication system. In the system, a communication layer is formed by macro-cells supported by base stations as is known in the art. The communication system can include multiple user equipment (UE) 112 (one shown), such as but not limited to a cellular telephone, a radio telephone, a personal digital assistant (PDA) with radio frequency (RF) capabilities, or a wireless modem that provides RF access to digital terminal equipment (DTE) such as a laptop computer. Furthermore, the communication layer of cells are supported by a large number of base stations each of which henceforth will be referred to as an evolved NodeB (eNB). Such eNBs can include wireless access points, NodeBs, Home NodeBs, or other type of wireless base stations, for example. As used herein, the term “cell” can refer to individual cell sites or different sectors within a cell site. For simplicity, in the description below it is assumed that each eNB has a single cell. In addition, the term “cell” can refer to macro-layer cells, pico-cells, femto-cells, etc.

The eNBs provide communication services to each UE residing in its coverage area, such as a cell of a 4G radio access network, via a wireless communication interface. Each eNB includes a transceiver or a Base Transceiver Station (BTS), in wireless communication with each UE and further includes a network controller, such as a Radio Network Controller (RNC) or Base Station Controller (BSC), coupled to the transceiver. The transceiver and controller can each includes a respective processor, such as one or more microprocessors, microcontrollers, digital signal processors (DSPs), combinations thereof or such other devices known to those having ordinary skill in the art. The particular operations/functions of processors, and respectively thus of the transceiver and controller, are determined by an execution of software instructions and routines that are stored in a respective at least one memory device, as are known in the art, associated with the processor, such as random access memory (RAM), dynamic random access memory (DRAM), and/or read only memory (ROM) or equivalents thereof, that store data and programs that may be executed by the corresponding processor.

The UE also includes a processor, such as one or more microprocessors, microcontrollers, digital signal processors (DSPs), combinations thereof or such other devices known to those having ordinary skill in the art. The particular operations/functions of the processor, and respectively thus of UE, is determined by an execution of software instructions and routines that are stored in a respective at least one memory device associated with the processor, such as random access memory (RAM), dynamic random access memory (DRAM), and/or read only memory (ROM) or equivalents thereof as are known in the art, that store data and programs that may be executed by the corresponding processor. The UE also has the processor coupled to a transceiver for communicating over the air interface with the eNB.

Under the control of one eNB 108, a UE 112 can periodically obtain the PCIDs 114, 118 from its neighbouring eNBs 106, 110 (only two shown in this example). The UE 100 will then report 116 these PCIDs through its serving eNB(s) to a cell operations and maintenance centre OMC 104 or EMS. Although only an OMC is shown here, for simplicity, it should be recognised that there can be many other network entities in the communication system including a mobile switching centre, serving gateway, radio network controller, etc. These are not shown for the sake of simplicity. The OMC 104 controls the operating parameters of the system. Each eNodeB contains an Automatic Neighbour Relationship (ANR) module 102 (only shown in 110 for example).

In the communication system, the cells of eNBs should each have a Physical Cell Identity (PCID) that is unique within a given region. The PCID may be reused in other areas as long a UE in one area can not access a cell in the other area having the same PCID. Specifically, each cell in an eNB should have an assigned PCID which is unique within the reuse area such that a set of defined neighbours for each cell always have different PCIDs. Each UE may be provided a neighbour list of neighbouring eNBs.

In typical operation, a UE 112 is served by a serving eNB 108. The UE 112 reads 114, 118 the PCIDs of its neighbouring eNBs 106, 110 of the neighbour list. The UE 112 then generates a measurement report which is transmitted 116 from the UE 112 to the eNB 108. Although this is straightforward in fixed communication systems, 4G cells can be added, moved, or removed quite easily, making permanent identification of neighbouring cells problematic.

The present invention addresses this issue by allowing new cells to determine their permanent PCID autonomously. In particular, the present invention first allows a new cell to temporarily use any PCID it chooses while operating on a non-standard frequency to determine the PCIDs already being used by its neighbours. This temporary operation is less problematic because in principle all 504 PCID codes are available in one start-up centre frequency. Clashes between two temporary cells are still possible but much less likely due to the non-standard frequency operation, hence many more new cells can be brought up simultaneously without risk and without reservation (or alternatively if reservation is used, 504 new cells or 168 new sites can be switched on at once per temporary frequency without any clash).

Operational cells also will not be affected by either direct PCID clash or confusion (two neighbours with same PCIDs) with a new eNB. The only possible side effect is due to band overlap, potentially causing problems in air interface decoding. However this is minimized since: (i) actual common channels can be arranged not to overlap since these are typically placed in the central portion of the band, (ii) since the frame/slot timing is different, the probability of reference symbols overlapping is small, and (iii) this is only problematic anyway for use of the same PCI in direct neighbours (i.e. it is a direct interference problem).

In operation, the present invention provides that each new eNB operates on an offset frequency in the temporary start-up phase. This offset frequency would be allowed by the standard whilst not being a normal operational frequency of the system, and the offset would be such that there should be no clash with any other centre frequencies, which contain the reference signals that the UE measures when reading or reporting the PCID. Using LTE as an example, the available central 72 tones, which are approximately 1 MHz apart, should not overlap with any other central 72 tones—e.g. the frequencies in use should be spaced by at least 1 MHz). The eNB can also have a desired operational frequency for each of its cells. Taking the case of a network with 3 contiguous frequencies (F1, F2, F3) with 5 MHz band each, temporary frequencies F1+1, F1+2, F1+3, F1+4, F2+1, etc can be defined. When a new eNB starts up in the network, it requests (or communicates) a temporary frequency with its OMC. The OMC will then need to inform existing eNBs that this frequency is in use (so this information is available to mobiles who may then make measurement report of cells with that frequency). An alternative embodiment would reserve a block of unused spectrum. e.g. 1 MHz is reserved only for temporary cells. Reservation of the spectrum could also be temporary and “stolen” from the edge of a band (by restricting operational eNBs not to use certain resource blocks, which would happen during new eNB introduction only). By definition, these cells will not clash with operational cells. However, this embodiment is less desirable as it removes spectrum from ordinary use.

In any case, the new eNB then enters operation using the temporary non-standard frequency and a random PCID. The probability of a direct PCID clash is very low since it would require another cell to use the same temporary non-standard frequency with the same random PCID. There could be close cells using the same PCID on a different frequency, but mobiles should be able to differentiate them if measurements are only made on the central 72 tones. In other words, if a signal is detected on a non-standard frequency, this indicates a new eNB is trying to establish a PCID on the system. The operational eNBs are made aware (by the OMC) of the “new” centre frequency of the new eNB, which is provided on cell broadcasts. The operational eNBs could also proactively request connected-mode low traffic mobiles to scan other frequencies, depending on the Automatic Neighbour Relations algorithm being used in the network (from ANR 102). Eventually, UEs in other cells start reporting the new cell or UEs will camp on the new cell. Either way, new X2 peer-to-peer messaging associations will be setup and the eNB will quickly build up its list of neighbours and neighbours' neighbours (according to mechanisms defined in the system standard). Hence a new eNB will be able to choose a new PCID for operation in the target frequency, in a localized manner, and with high probability of no clashes.

The present invention also provides means to resolve possible clashes when the new cell shifts into a permanent PCID/frequency since several such changes could occur simultaneously in the same area. The present invention provides three embodiments to address these possible clashes.

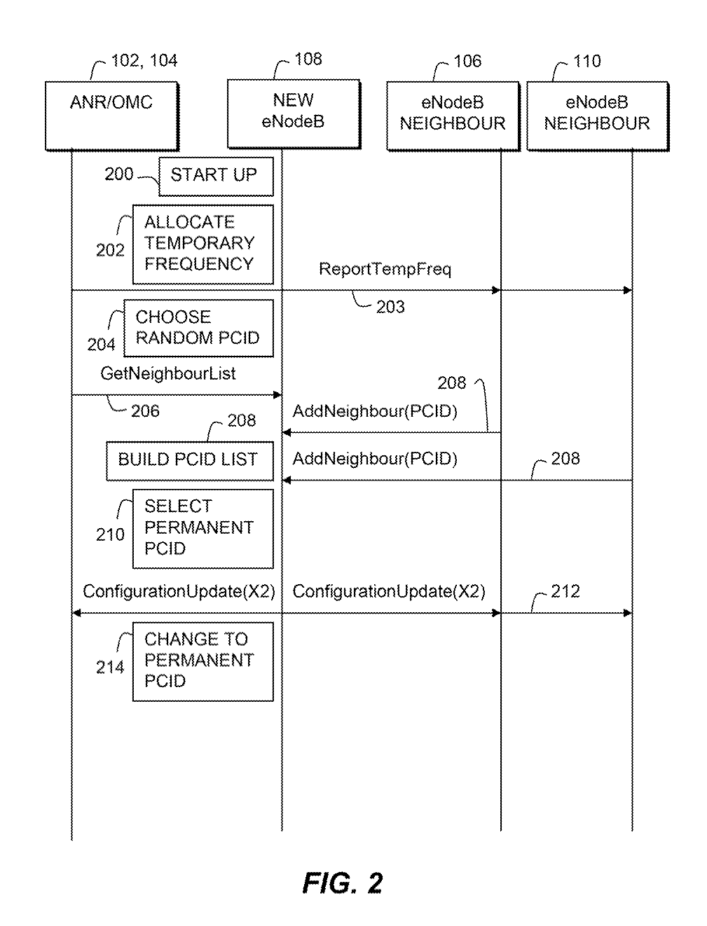

In a first embodiment of FIG. 2, a new eNB 108 starts up 200. A non-standard operating frequency is then allocated 202 to the new eNB 108. This allocation can be done either by the new eNB 108 requesting an unassigned non-standard operating frequency from the OMC, or by the new eNB choosing a non-standard operating frequency and reporting this to the OMC. The OMC can then report 203 this temporary operating frequency to other eNBs 106, 110 to inform existing eNBs that this frequency is in use (so this information is available to UEs who may then report cells with that frequency). Alternatively, all eNBs may be pre-configured with a list of potential temporary operating frequencies, and proactively request UEs to scan them on a regular basis. The new eNB 108 then chooses 204 a temporary PCID. This can be done by random selection or any other technique, such as through predefined numbers. The new eNB 108 can then use its temporary operating parameters to obtain a list of its neighbours from the ANR 102. The new eNB 108 can then build 208 a PCID list of its neighbours and neighbours' of neighbours using its temporary operating parameters. This can be done by obtaining neighbours' PCIDs through UE measurements or otherwise, and obtaining neighbour PCID lists from neighbouring eNBs 106, 110 through X2 peer-to-peer messages. Once the list is built, or after a predetermined convergence time, the new eNB 108 can choose an unused PCID from its built list, such as the lowest unused number, for example. In order to prevent any other cells from reconfiguring to this chosen number before the new eNB can complete its configuration, the new cell reports 212 a configuration change over X2 using the desired parameters in “Configuration Update” messages before the actual change is made. This configuration is propagated 212 by the new eNB 108, and stops at least immediate (temporary cell) neighbours 106, 110 from using the same PCID. In other words on receiving a configuration update, all recipients should suspend any reconfiguration action for a period of time that is long enough for the new eNB to complete its permanent change 214.

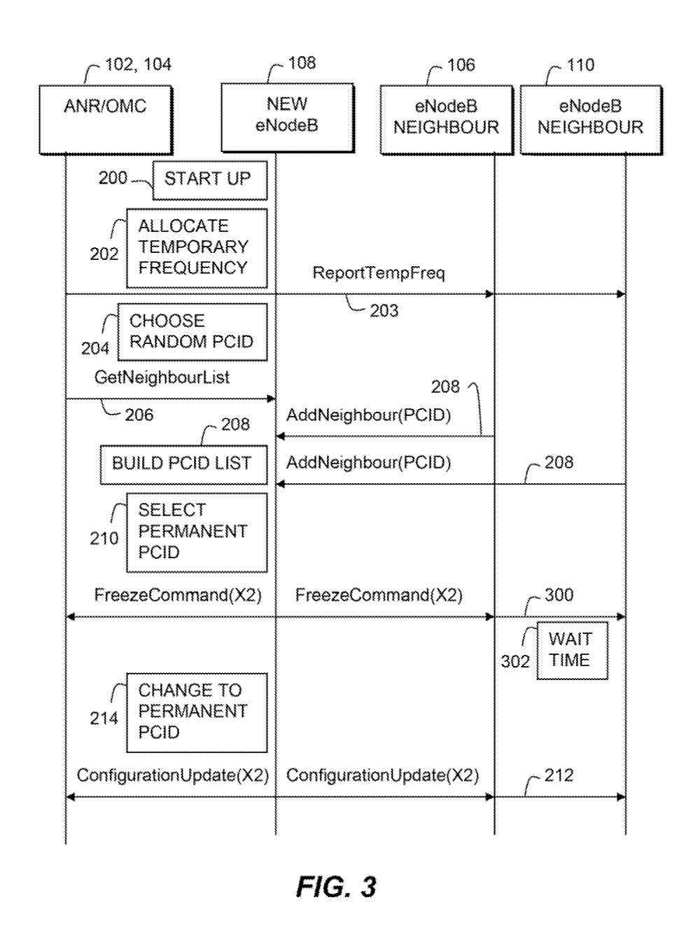

In a second embodiment of FIG. 3, steps 200-212 are performed the same as for the first embodiment of FIG. 1, and will not be repeated here for the sake of brevity. However, in this embodiment, the new eNB 108 sends 300 a “freeze configuration” command over X2 to its neighbours and neighbours' neighbours. Note that the cell may not have an X2 link to a neighbour's neighbour, but may set this up temporarily, and include a “time to wait” 302 that is long enough for the new eNB to complete its permanent change 214. Alternatively, the direct neighbours themselves may propagate the “freeze configuration” command to their own neighbours. Once its permanent PCID is established, the new eNB can send an “unfreeze configuration” command (not shown) to allow neighbouring cells to reconfigure their PCID at will, without the need for a wait time 302. In any case, as soon as the cell is reconfigured, the eNB should immediately send 212 “Configuration Update” messages over X2 listing the new eNB PCID, as in the first embodiment.

In a third embodiment, steps 200-212 are performed the same as for the first embodiment of FIG. 1, and will not be repeated here for the sake of brevity. However, in this embodiment, the new eNB 108 sends a “freeze configuration” request 400 to the OMC with a list of all cells in the neighbourhood of the new cell. The cells in the list are contacted 401 by the OMC and told not to make changes for a given wait time 402 that is long enough for the new eNB to complete its permanent change. Alternatively, when its permanent PCID is established, the new eNB can report this (not shown) to the OMC, which can then send an “unfreeze configuration” command to allow neighbouring cells to reconfigure their PCID at will. In any case, as soon as the cell is reconfigured, the eNB should immediately send 212 “Configuration Update” messages over X2 listing the new eNB PCID, as is the first embodiment.

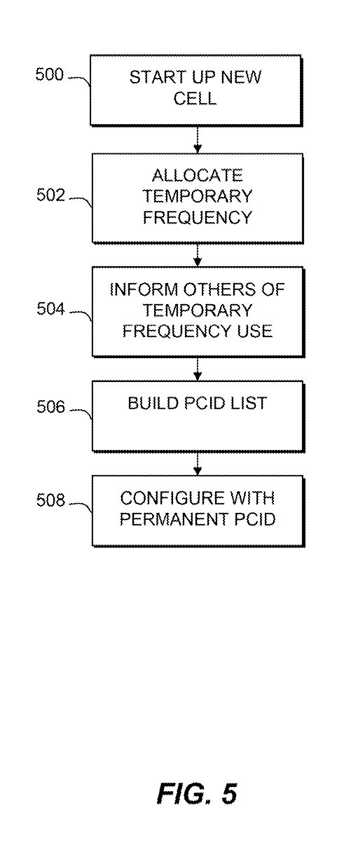

FIG. 5 illustrates an example of method for physical cell identity assignment in a wireless communication system. The method initiates in step 500 of starting up a cell in the communication system.

The method includes a next step 502 of allocating a temporary operating frequency for the new cell. This step includes allocating a temporary operating frequency that is offset from normal operating frequencies of the communication system. The temporary operating frequency can be allocated by the eNB processor, or can be requested from the OMC processor. Alternatively, the allocating step 502 allocates a temporary operating frequency that is from a block of an unused spectrum of frequencies of the communication system.

The method includes a next step 504 of informing other cells that the temporary operating frequency is in use.

The method includes a next step 506 of building a list of physical cell identity assignments being used by neighbouring cells. Preferably, the building step 506 includes the substeps of: obtaining physical cell identity assignments of neighbouring cells of the cell, and obtaining physical cell identity assignments of neighbouring cells of the neighbouring cells.

The method includes a next step 508 of configuring the new cell with a permanent physical cell identity assignment that is not being used in the list. Preferably, the configuring step 508 includes selecting a physical cell identity assignment that is not being used in any of the obtained physical cell identity assignments. This step 508 can also include sending a message listing the permanent physical cell identity assignment of the new cell. In the first embodiment of the present invention, this step 508 includes the substeps of propagating a configuration change with the selected physical cell identity assignment to neighbouring cells and neighbours of neighbouring cells in order to prevent any neighbouring cells from using the selected physical cell identity assignment, and changing to the selected physical cell identity assignment in the new cell. In the second embodiment of the present invention, this step 508 includes the substeps of sending a command to one or more of the neighbouring cells and neighbours of neighbouring cells with a time limit that stops any of the one or more neighbouring cells and neighbours of neighbouring cells from reconfiguring their physical cell identity assignment until the time limit expires, and changing to the selected physical cell identity assignment in the new cell. In the third embodiment of the present invention, this step 508 includes the substeps of sending the list to a network entity, sending a command to the cells on the list with a time limit that stops any neighbouring cells from reconfiguring their physical cell identity assignment until the time limit expires, and changing to the selected physical cell identity assignment in the new cell.

Advantageously, the present invention provides a technique for cells to self-determine their own physical cell identity assignments, thereby eliminating the need for a central network entity to assign physical cell identity assignments.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors.

The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

What is claimed is:

1. A method for physical cell identity assignment in a wireless communication system, the method comprising the steps of:
starting up a new cell in the communication system;
allocating a temporary operating frequency for the new cell;
building a list of physical cell identities being used by neighbouring cells; and
configuring the new cell with a permanent physical cell identities that is not being used in the list.

2. The method of claim 1, wherein the allocating step allocates a temporary operating frequency that is offset from normal operating frequencies of the communication system.

3. The method of claim 1, wherein the allocating step allocates a temporary operating frequency that is from a block of an unused spectrum of frequencies of the communication system.

4. The method of claim 1, further comprising a step of informing other cells that the temporary operating frequency is in use.

5. The method of claim 1, wherein the building step includes the substeps of:
obtaining physical cell identity assignments of neighbouring cells of the cell,
obtaining physical cell identity assignments of neighbouring cells of the neighbouring cells, and
wherein the configuring step includes selecting a physical cell identity assignment that is not being used in any of the obtained physical cell identity assignments.

6. The method of claim 1, wherein the configuring step includes a substep of sending a message listing the permanent physical cell identity assignment of the new cell.

7. The method of claim 1, wherein the configuring step includes the substeps of:
selecting a physical cell identity assignment that is not in the list,
propagating a configuration change with the selected physical cell identity assignment to neighbouring cells and neighbours of neighbouring cells in order to prevent any neighbouring cells from using the selected physical cell identity assignment, and
changing to the selected physical cell identity assignment in the new cell.

8. The method of claim 1, wherein the configuring step includes the substeps of:
selecting a physical cell identity assignment that is not in the list,
sending a command to one or more of the neighbouring cells and neighbours of neighbouring cells with a time limit that stops any of the one or more neighbouring cells and neighbours of neighbouring cells from reconfiguring their physical cell identity assignment until the time limit expires, and
changing to the selected physical cell identity assignment in the new cell.

9. The method of claim 1, wherein the configuring step includes the substeps of:
selecting a physical cell identity assignment that is not in the list,
sending the list to a network entity,
sending a command to the cells on the list with a time limit that stops any neighbouring cells from reconfiguring their physical cell identity assignment until the time limit expires, and
changing to the selected physical cell identity assignment in the new cell.

10. A method for physical cell identity assignment in a wireless communication system, the method comprising the steps of:
starting up a new cell in the communication system;
allocating a temporary operating frequency for the new cell that is offset from normal operating frequencies of the communication system;
informing other cells that the temporary operating frequency is in use;
building a list of physical cell identity assignments being used by neighbouring cells and neighbours of the neighbouring cell;
selecting a physical cell identity assignment that is not in the list; and
changing to the selected physical cell identity assignment in the new cell.

11. The method of claim 10, wherein the changing step includes a substep of sending a message listing the permanent physical cell identity assignment of the new cell.

12. The method of claim 10, wherein the changing step includes the substep of propagating a configuration change with the selected physical cell identity assignment to neighbouring cells and neighbours of neighbouring cells in order to prevent any neighbouring cells from using the selected physical cell identity assignment.

13. The method of claim 10, wherein the changing step includes the substep of sending a command to one or more of the neighbouring cells and neighbours of neighbouring cells with a time limit that stops any of the one or more neighbouring cells and neighbours of neighbouring cells from reconfiguring their physical cell identity assignment until the time limit expires.

14. The method of claim 10, wherein the configuring step includes the substeps of:
sending the list to a network entity, and
sending a command to the cells on the list with a time limit that stops any neighbouring cells from reconfiguring their physical cell identity assignment until the time limit expires.

15. A new cell operable to provide itself a physical cell identity assignment in a wireless communication system, the cell comprising:
a base station, wherein upon start up the base station is operable to obtain a temporary operating frequency for the new cell, build a list of physical cell identities being used by neighbouring cells, and configure the new cell with a permanent physical cell identity assignment that is not being used in the list.
